(19) United States
(12) Patent Application Publication
(10) Pub. No.: US 2018/0373672 A1
(43) Pub. Date: Dec. 27, 2018

(54) CALCULATING DEVICE AND METHOD

(71) Applicant: KONINKLIJKE PHILIPS N.V., EINDHOVEN (NL)

(72) Inventor: LEANDRO MARIN, MURCIA (ES)

(21) Appl. No.: 15/781,866

(22) PCT Filed: Dec. 7, 2016
(86) PCT No.: PCT/EP2016/079971

§ 371 Date: Jun. 6, 2018

(30) Foreign Application Priority Data
Dec. 7, 2015 (NL) 2015911

(51) Int. Cl. G06F 17/11; G06F 17/16; G06F 7/544; G06F 17/30

(52) U.S. Cl. CPC G06F 17/11; G06F 17/30952; G06F 7/5443; G06F 17/16

(57) ABSTRACT

An electronic calculating device arranged to add two elements of a main group ((M, +)), the main group being a finite Abelian group Formula (I), the calculating device comprising—an addition table storage (110) storing for each element (mᵢ) of the second subset (M₀) a look-up table (Pᵢ), —an addition unit arranged to receive a first addition input (α₀X₀) and a second addition input (γ₀mᵢ₀h⁰+γ₁mᵢ₁h¹+γ₂mᵢ₂h²+ . . . ), the first and second addition inputs being elements of the main group (M), wherein the first addition input is received in normalized representation and the second addition input in generalized representation, and to compute a sum in the main group (M) of the first addition input and the second addition input.

### FIELD OF THE INVENTION

The invention relates to an electronic calculating device, an electronic calculating method, a table computation device, a table computation method and a computer program and a computer readable medium.

### BACKGROUND

In white-box cryptography and more in general software obfuscation, computations are often performed on encoded values instead of plain values. Reverse engineering of the obfuscated software is harder if computations are performed on encoded values, instead of on the plain values themselves.

After the encoding, regular operations, like addition or multiplication, can no longer be performed using a computer's built-in primitives. The straightforward addition of encoded values does not normally result in the encoding of the addition of the values. The same holds for multiplication. In a formula: E(x)+E(y)≠E(x+y), for most x and y; E denotes the encoding function.

A solution to this problem is to introduce addition (A) and multiplication (M) tables. The tables take two encoded values as input and produce an encoded value as output that corresponds to the encoding of the addition or multiplication operation. The tables may be defined as: A(E(x), E(y))=E(x+y); M(E(x), E(y))=E(xy). These tables allow arithmetic to be performed directly on encoded values.

The obfuscated addition and multiplication using tables suffers from at least two drawbacks. First, the tables can become quite large. If x and y are represented as 1 bits, each table needs 2^{2l}l bits. Furthermore, encodings may be fixed, which opens the possibility for an attacker to make a list of possible encodings.

### SUMMARY OF THE INVENTION

It would be advantageous to have a calculating device which addresses these and other concerns.

The inventors devised a way in which additions may be performed on encoded values using tables that are much smaller than the one discussed in the background: approximately 2^{l}l bits are needed per table. Moreover, the system is applicable to all Abelian groups making it widely applicable. Furthermore, in addition to having small tables and a large application scope, the number of potential encodings remains large, thus improving security.

In fact, the system allows different representations for the same element without resorting to redundant variables. This means the multiple different encodings are not easily collapsed. Moreover, the system allows different encodings used for external data (generalized representations) than are used internally. Moreover, the number of possible representations may be increased to a point at which no external representation needs to be used more than once, further reducing possibilities for an attacker to effectively use a list of possible encodings.

The invention applies to many different commutative groups M. Commutative groups, also known as Abelian groups are a mathematical concept that includes many different familiar mathematical structures, e.g., the integers modulo a number ( [symbol] ₙ) or the polynomials modulo a number and a polynomial ( [symbol] ₙ[x]/f(x)). In an embodiment, the system is extended to commutative rings.

As will be discussed more fully herein, there are many possibilities and variants. It will be typically unknown to an attacker which one of many variants has been chosen in any given implementation.

The calculating device is an electronic device and may be a mobile electronic device, e.g., a mobile phone, a set-top box, a computer, a smart card, etc.

Arithmetic as described herein may be applied in a wide range of practical applications. Such practical applications include secure applications running on private hardware, e.g., banking applications etc, wherein reverse engineering is to be prevented. Other applications include applications wherein inadvertent leaking of data is to be prevented. If a program is tricked into releasing private data this is less of a concern if the leaked data is encoded. The arithmetic may also be applied to servers running applications. Privacy is increased if users send and receive data in encoded form.

A method according to the invention may be implemented on a computer as a computer implemented method, or in dedicated hardware, or in a combination of both. Executable code or parts thereof for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer

In a preferred embodiment, the computer program comprises computer program code means adapted to perform all the steps of a method according to the invention when the computer program is run on a computer. Preferably, the computer program is embodied on a computer readable medium.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1a schematically shows an example of an embodiment of a calculating device 100,

FIG. 1b schematically shows an example of an embodiment of an addition unit 130,

FIG. 1c schematically shows an example of an embodiment of a multiplication unit 140,

FIG. 1d schematically shows an example of an embodiment of a calculating device 100′,

FIG. 2 schematically shows an example of an embodiment of a calculating device 101,

FIG. 3 schematically shows an example of an embodiment of a table computation device 200 for computing an increment table for use in a calculating device,

FIG. 4 schematically shows an example of an embodiment of a calculating method 300,

FIG. 5 schematically shows an example of an embodiment of a table computation method 400,

FIG. 6a schematically shows a computer readable medium having a writable part comprising a computer program according to an embodiment,

FIG. 6b schematically shows a representation of a processor system according to an embodiment.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described above or recited in mutually different dependent claims.

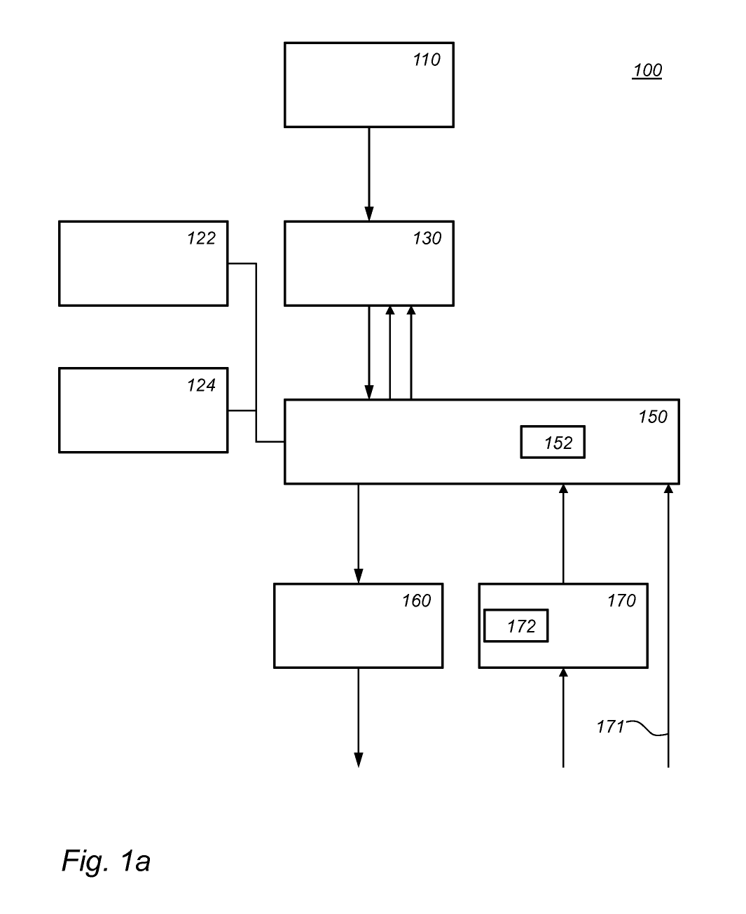

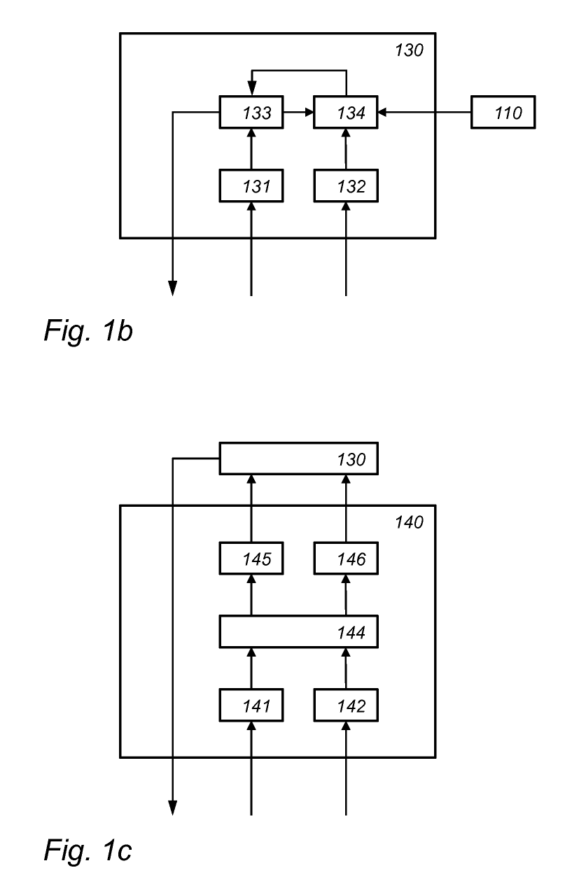

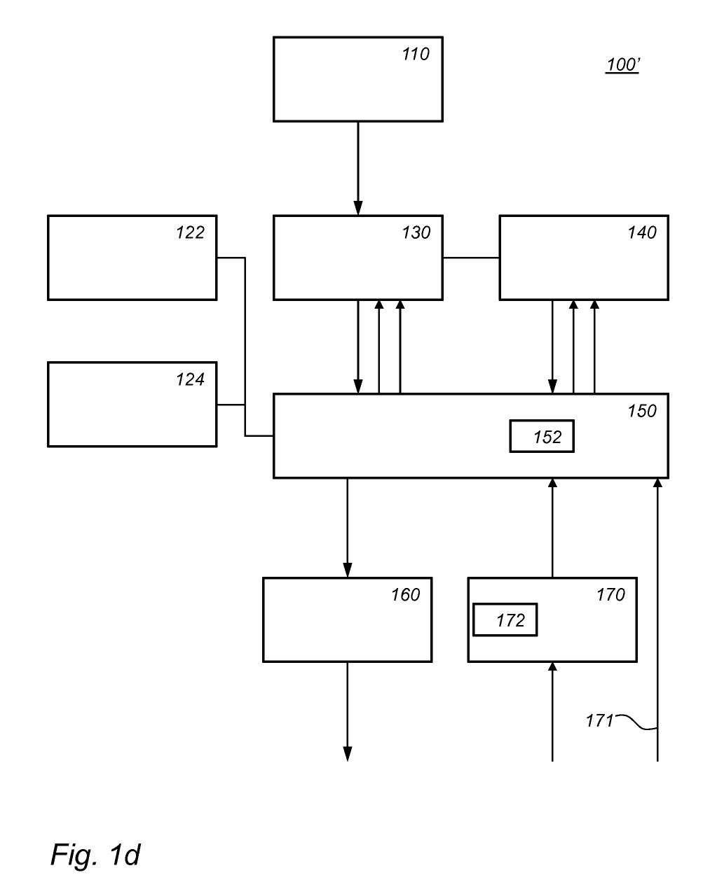

FIG. 1 illustrates in schematic form an embodiment of an electronic calculating device 100. Calculating device 100 is arranged to add two elements of a main group (M, +). The main group is represented by a set of elements M, and a binary operation defined for each pair of elements of the M, indicated with +. The main group satisfies the normal mathematical requirements for being a group (the addition is associative, there is a two-sided identity element, and each group element has an inverse). Furthermore, the group is restricted to being finite and Abelian. The latter implies that the group may be represented as [symbol] ₚ_{₁}k₁ ⊕ . . . ⊕ [symbol] ₚ_{ₜ}kₜ, for some primes pᵢ and exponents kᵢ. For the main group, the addition may be denoted as +. Note that even if we denote the group operation as + or its identity as 0, this does not imply that the calculating device must be restricted to addition in the traditional arithmetic sense. Although, say the group of addition modulo a modulus is an Abelian group to which the calculating device may be applied, it is not restricted thereto, but may instead be applied to any Abelian group. All groups and sets are finite and non-empty.

The calculating device 100 is arranged to compute the addition in the group. The group elements are obfuscated by encoding them. Obfuscation of the group elements is beneficial to security, as an attacker who attempts to reverse engineer the calculating device does not know the encoding that was used. Accordingly, even if the attacker is capable of observing the inner workings of the calculating device, he does not know what the device is calculating.

Interestingly, calculating device 100 encodes group elements in two different ways, termed for the purpose of the patent: normalized representation and generalized representation. The inventors have found that such representations may be found for all finite Abelian groups. Furthermore, a group may allow for many different choices of normalized and generalized representations. The latter also improves security, for if only one or a few encodings were available, then an attacker who has knowledge of the general encoding system may try all possible encodings, and find out which encoding was used. The latter line of attack becomes however infeasible if many choices for the encoding are available.

Moreover, both the normalized and generalized representations may allow for multiple different representations of the same elements. In particular, the generalized representation may be easily adapted to allow for many different representations of the same group element. Again this is beneficial for security; one potential line of attack could be to try and make a translation table that maps group representations to a more conventional representation. However, this is harder if there are more representations for the same element.

The normalized and generalized representations are defined with respect to a number of sets discussed below. The choice of these sets determines the representations and also how they are added, in particular the look-up tables used in the addition (further discussed below).

Defined for the main group are a first acting group N and a second acting group H. Both of these groups act on the main group M. Note: a group A acts on a group B, if for all g in A and x in B an element g·x is defined of group B. The identity element of the group A does not change x, moreover, (g₁g₂)·x=g₁·(g₂·x), for any g₁ and g₂ of A.

The second acting group H is a cyclic group generated (H= [symbol] h [symbol] ) by a generating element (h). Both acting groups are finite. There is some exponent k called the order, so that h^{k} is the identity. Both the first and second acting groups are groups in the mathematical sense. The acting of an acting group on the main group is referred to as a product. The identity of an acting group may be referred to as 1. So that, e.g., h^{k}·x=1·x=x. Note that the second acting group has been notated as right acting for convenient notation.

The first acting group N and a second acting group H have been chosen to have the property that (nm)h=n(mh) for all n ∈ N, m ∈ M, h ∈ H.

The first and second acting groups may be selected as subgroups of the automorphism group of M, e.g., the set of isomomorphisms of the main group M to itself. This shows that a first and second group can always be selected. The second acting group can be selected by selecting an element h of the automorphism group of M and setting H=<h>, i.e., the group generated by h. For example, the first and second acting groups may be obtained as matrix groups.

Although it is not necessary, in embodiments the first acting group is a matrix subgroup N of [symbol] (M), and h is another matrix that commutes with the generators of first acting group N. In this case we can use column vectors for the elements of M and write all matrices on the left with standard matrix multiplication. Although a matrix and vector notation for the acting groups and M respectively is convenient, and may for example be used to compute in the acting group or to compute the addition tables, this format need not be used in the calculating device itself where, e.g., an encoded representation may be used.

The computations in calculating device 100 may require calculations to be performed in the acting groups. If an acting group is cyclic, e.g., as the second acting group is, this may be done by calculating on de exponent modulo to order of the group. In any case, a table may be used to represent the group operation in the acting groups.

Also defined for the main group are a first subset Δ of the main group M such that any element m of the main group M can be expressed as m=nX, e.g., as a product of an element n of the first acting group N and an element X of the first subset Δ. Another way of saying this, is that the orbit of the first subset Δ under the action of the first acting group N equals the main group.

Given a first acting group N and a main group M such a first subset Δ is guaranteed to exist, since N·M=M. For example, a first subset may be found by determining the orbits in M induced by N and selecting at least one element of each orbit. A first subset Δ of smallest size may be found by selecting exactly one element of each orbit. Two elements a and b of M are in the same orbit if there exists an n in N such that na=b. Selecting more elements from the same orbit increases the number of normalized representations.

Any element m of M may be represented as a pair of an element n of the first acting group N and the element X of the first subset Δ for which m=nX. The latter representation is referred to as a normalized representation. By selecting a different first acting group and/or a different first subset, many different normalized representations may be obtained.

Internally, the pair (n, X) may be represented by a pair of integers. For example, the element n may be represented by an integer that encodes the particular element of N. For example, the element X may be represented by an integer that encodes the particular element of first subset Δ. This encoding does not need to be canonical. For example, the integer encoding may be obtained by imposing a random order on the first acting group and/or the first subset, and representing an element in the first acting group and/or first subset as an index in the order. Alternatively, the elements n and X may be represented in a conventional, e.g., canonical, representation. The latter representations may themselves be encoded, e.g., encrypted.

Also defined for the main group is a second subset M₀={m₀, . . . , mᵣ₋₁} of the main group M such that any element m of the main group M can be expressed as a sum of multiple summands, each summand being a product of an element γₜ of the first acting group N, an element mᵢ_{ₜ} of the second subset M₀ and a power h^{t} of the generating element. For example, m=Σₜγₜmᵢ_{ₜ}h^{t}. A generalized element may, e.g., be written as: m=γ₀mᵢ_{₀}h⁰+γ₁mᵢ_{₁}h¹+ . . . +γₖ₋₁mᵢ_{_{k−1}}h^{k-1}. In the latter case the highest exponent is the order of the second acting group, i.e., the order of h, minus 1. More in general, the index t may be limited to λk−1, i.e., a multiple of the order of h minus 1. A highest exponent of k−1 is often sufficient, although not for all groups. Below we will generally assume that the generalized representation use powers of h of at most k−1, unless mentioned otherwise. Nevertheless, the examples given below may be extended to a larger exponent, e.g., if more generalized representations are desired.

Given a second subset M₀ that allows all elements of M to be represented, the set nM₀h^{j} is also a valid second subset; with n and h^{j} in the first and second acting group respectively.

An element in generalized form may be represented as two sequences: {γ₀, γ₁, . . . , γₖ₋₁} and {mᵢ_{₀}, mᵢ_{₁}, . . . , mᵢ_{_{k−1}}} or {i₀, i₁, . . . , iₖ₋₁}. The latter sequence is an example of representing elements by their index in a list. Also the elements γᵢ may be represented as an integer, e.g., as an index in a list representation of N. In an embodiment, the second subset contains a single element m₀; in this case the second sequence does not need to be explicit but may be implicit. In an embodiment, the sequences have the same length for all elements of M. In an embodiment, the sequences have an entry for each power of h from 0 up to the bound on h, e.g., k−1 or λk−1 for λ>1.

The two sequences may also be represented as a single sequence, e.g., as {γ₀, mᵢ_{₀}, γ₁, mᵢ_{₁}, . . . , γₖ₋₁, mᵢ_{_{k−1}}}

We have the following bounds #N·#Δ≥#M, and (#N·#M₀)^{#H}≥#M, wherein

#N is the size of the first acting group (N),

#H is the size of the second acting group (H),

#Δ is the size of the first subset (Δ),

#M₀ is the size of the second subset (M₀),

#M is the size of the main group (M).

Moreover, none of the first acting group (N), the second acting group (H), the first subset (Δ), the second subset (M₀), and the size of the main group (M) are empty. If desired, the number of normalized representations can be upper bounded compared to the size of the main group M; for example, in some embodiments 2#M≥#N·#Δ. This can have an advantage, as limiting the number of normalized elements reduces size of addition tables. Note however, that this is not necessary, in particular, it may be desired that the number of representations, especially of generalized representations is large compared to the size of the group. For example, the number of normalized representations may be increased by selecting a larger first acting group or larger first subset; the number of generalized representations may be increased by allowing a larger exponent for h or selecting larger acting groups or a larger second subset.

FIG. 1 shows an operand storage 150. Operand storage 150 stores elements of group M that are to be added. Other operations than addition may also be performed on the elements in operand storage 150, e.g., multiplications, etc. Operand storage 150 comprises operands in normalized representation and in generalized representation. Part of operand storage 150 may be a constant storage 152 arranged to store one or more constant addition inputs in normalized representation. Operand storage 150 may also comprise constants in generalized form. After elements of M have been added or otherwise computed with, they can be stored again in operand storage 150, e.g., as a working memory.

Calculating device 100 comprises an addition table storage 110 storing for each element mᵢ of the second subset M₀ a look-up table Pᵢ. Such a look-up table takes as input a normalized element (γ, X) of the main group M and maps the input to an element λ of the first acting group N and an element Y of the first subset Δ, such that a product of the element λ of the first acting group N and the element Y of the first subset Δ is the sum of the normalized element γX and said element mᵢ of the second subset M₀: λYh=γX+mᵢ. For example, the look-up table Pᵢ maps Pᵢ(γ, X)=(λ, Y), such that λYh=γX+mᵢ. In an embodiment, the look-up table for element mᵢ maps a normalized input to a normalized output element such that the normalized input plus the element mᵢ (in group M) equals the normalized output times the generating element h (using the action of the second action group).

Note that the look-up table takes only a single element of M in normalized form as input. The size of the table is commensurate with the number of normalized elements, which may be about the size of M itself. Nevertheless, such tables may be used to add two elements of M. Note, that a table which takes two inputs to compute a sum would grow with the size of M squared. This means that even if the size of the group M is chosen to be large, say larger than 512 or larger than 1024 elements, that the size of the tables grow approximately linearly, not quadratically.

Calculating device 100 comprises an addition unit 130. Addition unit 130 is arranged to receive a first addition input and a second addition input, the first and second addition inputs being elements of the main group M; for example through a interface of addition unit 130. The first addition input is received in normalized representation, e.g., α₀X₀ with α₀ in the first acting group N, and X₀ in the first subset. The second addition input is received in generalized representation, e.g., γ₀mᵢ_{₀}h⁰+γ₁mᵢ_{₁}h¹+γ₂mᵢ_{₂}h²+ . . . . Addition unit 130 is arranged to compute the sum of the first and second addition input in the main group M.

Addition unit 130 is arranged to compute partial sums by sequentially adding the summands of the second addition input to the first addition input. Adding a summand γₜmᵢ_{ₜ}h^{t} of the second addition input to the partial sum involves applying the look-up table Pᵢ_{ₜ} stored in the addition table storage 110 for the element mᵢ_{ₜ} of the second subset M₀ in said summand.

FIG. 1b illustrates an embodiment of addition unit 130. Addition unit 130 receives a first addition input 131, and a second addition input 132. Addition unit 130 comprises a partial addition unit 134 arranged to iteratively add a summand obtained from second addition input 132 to the first addition-input element. For example, the partial addition unit 134 may add to a partial sum 133 which is initialized to the first addition input 131. The addition involves an application of a look-up table from storage 110. Mathematical details of embodiments are further discussed below.

For example, the addition unit may be arranged to set partial sum 131 initially to the first addition input α₀X₀, and to loop over the summand of the first addition input, in each loop updating the partial sum by adding the summand of the first addition input γₜmᵢ_{ₜ}h^{t}. Below an example algorithm is given that may be used by addition unit 130 to add the first and second addition input.

The first addition input 131 is initialized to the element (α₀, X₀) of the main group with α₀ ∈ N, and X₀ ∈ Δ; for example first addition input 131 may be represented as the pair {α₀, X₀}. The second addition input is the element γ₀mᵢ_{₀}h⁰+γ₁mᵢ_{₁}h¹+γ₂mᵢ_{₂}h²+ . . . γ_{λk-1}mᵢ_{_{λk−1}}h^{λk-1} of the main group, wherein k is the order of the generating element, γᵢ ∈ N, and mᵢ ∈ M₀, and h is the generating element. We will assume λ=1, but note that the formulas below directly extend to the case with λ>1. For example second addition input 132 may be represented as the sequence {γ₀, mᵢ_{₀}, γ₁, . . . , γₖ₋₁, mᵢ_{_{k−1}}}.

Addition unit 130 may be arranged to compute the following sequence of partial results obtained as a result of applying one of the addition tables P. Below the normalized input and output of a look-up table Pᵢ has been represented as a pair of an element of the first acting group N and an element of the first subset Δ.

(α₁, X₁)←Pᵢ_{₀}(γ₀⁻¹α₀, X₀)

(α₂, X₂)←Pᵢ_{₁}(γ₁⁻¹γ₀α₁, X₁)

(α₃, X₃)←Pᵢ_{₂}(γ₂⁻¹γ₁α₂, X₂)

(αₖ, Xₖ)←Pᵢ_{_{k−1}}(γₖ₋₁⁻¹γₖ₋₂αₖ₋₁, Xₖ₋₁)

For example, addition unit 130 may be arranged to set the partial sum initially to the first addition input (α₀, X₀). For each exponent t of the generating element h, e.g., from 0 to λk−1, partial addition unit 134 obtains the next partial sum (αₜ₊₁, Xₜ₊₁) from the current partial sum (αₜ, Xₜ) by adding the summand corresponding to the power γₜmᵢ_{ₜ}h^{t}. The latter involves applying the look-up table Pᵢ_{ₜ} for mᵢ_{ₜ} to (γₜ⁻¹γₜ₋₁αₜ, Xₜ), wherein γ₋₁ is the identity in the first acting group and wherein (αₜ, Xₜ) is the current partial sum stored in partial sum 133.

The partial sums (αᵢ, Xᵢ) in partial sum 133 represent the partial sums of the first and second addition input. Although partial sums (αᵢ, Xᵢ) are not identical to said sums, we have that the value γₜ₋₁αₜXₜh^{t} does equal the partial sum, e.g. the sum of the first addition input and the first t summands of the second addition input. It turns out to be efficient to represent the partial sum such that the partial sums equal the value γₜ₋₁αₜXₜh^{t}. The leads to a short sequence of computations. Other representations are possible however, in particular the partial sums could be represented by normalized elements that are directly equal to the partial sum (without a constant) but this would unnecessary complicate the addition. Note that the partial sums are in normalized representation. Through substituting the definition of the addition table and partial sums, it can be verified that the above algorithm indeed produces the correct result. Note that the algorithm includes computations in the first acting group. Such computation may be performed in any conventional manner, e.g., using some canonical representation of the first acting group, or by storing a table indicating the results of computations in the first acting group, etc.

As a result of the algorithm, we have for the final partial sum of the above algorithm (αₖ, Xₖ) that (γₖ₋₁αₖXₖ) equals the sum of the first and second addition input. If desired the addition unit 130 may be arranged with a further step in which γₖ₋₁αₖ is computed. The pair {γₖ₋₁αₖ, Xₖ} represents the sum in normalized representation. Below we will assume that the final normalized output has been transformed by multiplying the element in the first acting group with γₖ₋₁. Note however that this last step is not necessary. For example, the final multiplication may be incorporated with a next operation that is performed on the same element. Especially in an obfuscated implementations there is benefit in postponing the corrective multiplication. For example, the final partial sum may be regarded as an encoded sum. To obtain the final normalized output of the addition also γₖ₋₁ is needed and that may not be available to the attacker.

In an embodiment, addition unit 130 takes as input two elements, one in normalized and one in generalized representation, and produces as output an element in normalized representation. In an embodiment, an addition unit 130 takes as input multiple elements, e.g., more than two, one in normalized representation and the rest in generalized representation, and produces as output the sum in normalized representation. For example, the normalized element may be added to each generalized element, producing normalized elements as partial sums until all generalized elements have been added, the final sum of the multiple elements being in normalized representation.

The above example algorithm adds normalized elements with generalized (non-normalized) ones. The addition uses a normalized input. A normalized input may be obtained by normalizing a generalized operand, or by using an output taken from a previous addition or other normalized function, or a normalized constant.

In an embodiment, the external inputs to calculation device 100 may be chosen to be non-normalized. This avoids repetition of values, generally we have much more non-normalized elements than normalized ones. For example, in an embodiment a number of non-normalized elements may be used and not use again thereafter.

For example, if it is desired to compute x+c with an input value x and a constant c, one may compute c+x with c given in normalized form and x in non-normalized form. It is even better to compute (d+x)+e with d+e=c, wherein d is in normalized form and x, and e are in non-normalized form. In the latter form the computation does not reveal the normalized value of c, which makes it difficult to the attacker to know the real values hidden under the values that appear in the process. The value c or the values d and e may be stored in operand storage 150, e.g. in constant storage 152. The value d may be chosen at random, and value e chosen such that d+e=c.s

If it is necessary to compute the addition of two non-normalized values, it is possible to include a normalized constant (or constants) that can start the chain of operations. For example, a normalized representation of 0+x+y could replace the computation of x+y if x and y are both non-generalized. The constant 0 is represented as a normalized element. If it is necessary to add two normalized elements, it is possible to replace one of them, say the second by a generalized representation. For example, this may be done by a map, say a table, that maps for all X ∈ Δ a generalized representation for X. In an embodiment, the map comprises multiple generalized representations for X, so that a choice for the generalized representation for X is not unique and provides some flexibility to obfuscate the choice.

In an embodiment, calculating device 100 comprises a network interface arranged to receive one or more addition inputs from a computer external to the electronic calculating device. The one or more addition inputs being in generalized representation; in addition to the one or more addition inputs also other inputs may be received, some which may be in normalized representation. In constant storage 152 one or more constant addition inputs are stored in normalized representation. The calculating device 100 is arranged to add a selected addition input in generalized form received through the network interface and a selected constant addition input in normalized from constant storage 152, using the addition unit. In general, calculating device 100 may comprise a calculating controller arranged to control on which operands in operand storage 150 which operations, e.g., additions are performed. The calculating controller is not shown separately. In an embodiment, the constant storage comprises a pair (d, e) with d normalized and e generalized, the constant d being added first to the selected addition input followed by addition of constant e. The resulting normalized element may be stored in operand storage 150.

It is relatively easy to arrange the calculating system so that there are many more generalized representations than normalized representations. Having more choice outside of the device improves security in the outside communication. For example, in an embodiment a plurality of sensors (or other devices) communicate sensor data (or other data) encoded in generalized representations. Each sensor has access to a private subset of all generalized representations, e.g., no two of said plurality of private subsets overlapping more than a threshold of elements, say less than 10% of the size of any of said two private subsets. In an embodiment, no two of said plurality of private subsets overlap. This has the advantage that two sensors communicate their data using different representations. An attacker who has access to a sensor and has somehow found the relationship between sensor data and their generalized representation cannot use this mapping to decode communication intercepted from a different sensor. Note that even though it is easier to create multiple or even many generalized representations, any given group element may also be represented by multiple normalized representations.

In an embodiment, the calculating device 100 comprises a conversion unit 150 arranged to receive a conversion input.

For example, the conversion input may be in generalized form and is to be converted to normalized form. In this case conversion unit 150 may be arranged to convert the conversion input to normalized form by adding an element of the main group in normalized form. The element may be 0. The conversion unit 150 may also add a non-zero element, in which case subsequent operations may be adapted that the input has been modified, e.g., as an encoding. The conversion unit 150 may also add multiple elements that sum to 0, at least one of which being in normalized form.

For example, the conversion input may be in normalized form and is to be converted to generalized form. In this case conversion unit 150 may be arranged to store a conversion table mapping elements of at least the first subset to a generalized form. For example, if according to the map the X in normalized form nX is mapped to γ₀mᵢ_{₀}h⁰+γ₁mᵢ_{₁}h¹+γ₂mᵢ_{₂}h²+ . . . +γ_{λk-1}mᵢ_{_{λk−1}}h^{λk-1}, then the normalized form nX maps to n(γ₀mᵢ_{₀}h⁰+γ₁mᵢ_{₁}h¹+γ₂mᵢ_{₂}h²+ . . . +γ_{λk-1}mᵢ_{_{λk−1}}h^{λk-1})=(nγ₀)mᵢ_{₀}h⁰+ . . . +(nγ_{λk-1})mᵢ_{_{λk−1}}h^{λk-1}. The transformation of a sequence representing X to a sequence representing nX may be done by computing in the first acting group.

The conversion unit allows addition of two elements of the main group regardless of the representation. For example, if two elements are both in normal representation, one of them may be converted to generalized representation. For example, if two elements are both in generalized representation, one of them may be converted to normal representation.

An embodiment of calculating device 100 comprises a function unit 124. Function unit is arranged to apply a linear function ƒ to a function input in generalized form. For example, the generalized form may be received from operand storage 150.

The function input comprises a linear function table storage in which a table is stored taking as input a product of an element γₜ of the first acting group N, an element mᵢ_{ₜ} of the second subset M₀ and a power h^{t} of the generating element m=Σₜγₜmᵢ_{ₜ}h^{t} and mapping the product to the result of applying the linear function to the product. The function unit is arranged to apply the table of the linear function table storage to the summands of the function input. For example, the input γ₀mᵢ_{₀}h⁰+γ₁mᵢ_{₁}h¹+γ₂mᵢ_{₂}h²+ . . . +γ_{λk-1}mᵢ_{_{λk−1}}h^{λk-1} is mapped to the output f(γ₀mᵢ_{₀}h⁰)+ . . . +f(γ_{λk-1}mᵢ_{_{λk−1}}h^{λk-1}). Note that the number of possible summands in the generalized representation is much smaller than the number of generalized representations. Thus the table needed to compute linear function ƒ is much smaller than would be needed for a table that takes any generalized element as input. Non-linear operations may be executed on elements of main group M, may be executed, e.g., by a table.

The principles set out herein are applicable to a wide range of Abelian groups and allow a large number of representations. Below a number of choices within these large number of possibilities is given. Extensive experiments performed by the inventor have shown that for all of these choices many possible main groups M are possible.

In an embodiment, the order of h is restricted. For example, in an embodiment, the second acting group H has 3 elements, or the second acting group H has 2 elements. More generally, the order is less than 4 or 8 or 16, etc. In combination, the upper bound for the exponent in generalized representation may be taken to be k−1. The number of steps taken during an addition increases with the size of H. By selecting an H that is comparatively small, say having 2 or 3 elements, the addition has fewer steps and computation is faster.

In an embodiment, the second subset M₀ has at least 2 elements. Increasing the number of elements in the second subset increases the number of generalized representations. In particular, the number of generalized representations may be increased to a point that any generalized representation needs to be used only once. The latter completely eliminates an attack based on straightforward construction of a conversion table from generalized representations.

In an embodiment, the number of elements in the second subset is restricted. As the size of the second subset increases so do the number of tables in addition storage 110. For example, the number of elements in the second subset is less than 4 or 8 or 16 etc. In particular, the number of elements in the second subset may be 1. In an embodiment, the second subset M₀ has 1 element which is not the identity.

The options given above may be combined. For example, in an embodiment, the second subset may have only a single element, and the second acting group may have exactly 2 elements. By selecting a sufficiently large first acting group all elements of M may still be represented.

Convenient for implementation are choices in which N is a cyclic group, say a cyclic group with at least 3 elements. In this case, N is generated by some elements, and elements of N may be represented as an exponent of the generating element. The exponent may be stored in encoded form. Advantageously, the generating element can be kept secret.

The Abelian group M may be group of integers modulo a modulus n: [symbol] ₙ. By combining multiple of these groups in a residue number system, arithmetic may be performed over arbitrarily large numbers. Advantageously, the numbers representing exponents in these groups may be represented according to one or more of the embodiments, creating a recursive definition. The modulus n may be larger than, say, 8.

The Abelian group M may also be the Abelian group [symbol] ₂^{l}, for example, with l≥4, having 2^{l} elements (not to be confused with the group [symbol] ₂l) is particularly suited for binary computations, in particular the XOR operation.

The group above has characteristic 2. This can be combined with a small second acting group H, in particular with a second acting group H having two elements. For example, H may be generated by the element h=−1. In this case to get enough generalized elements the power h^{t} of the generating element h in a generalized representation needs to be allowed to exceed the order minus (k−1). In an embodiment, the exponent in a generalized representation is at most the twice the order minus 1, e.g., t≤2k−1.

If the main group M has characteristic larger than 2 or the order of the second acting group is larger than 2, then the exponents of h in a generalized representation may be restricted to at most the order minus 1, e.g., t≤k−1. Advantageously, the generating element can be kept secret and the tables are relatively small. The number of generalized elements may be as large as desired, e.g., by choosing a larger H, M₀, etc.

For some embodiments it is desired that there are more generalized elements than normalized elements; for example, if generalized elements are used to protect external inputs. This can be obtained by selecting the second acting group, the allowable exponents, the second subset, and even the first acting group sufficiently large. In an embodiment, (#N·#M₀)^{#H}≥3/2#N·#Δ, that is the number of generalized representations is at least 3/2 of the number of normalized representations, more in particular wherein (#N·#M₀)^{#H}≥5/2#N·#Δ, etc.

A discussed above, the elements of the first subset Δ may be chosen from the orbits induced by the first acting group on the main group M. In an embodiments, the elements of the first subset Δ are obtained from the first and second acting group and second subset, namely the elements formed by summing products of elements of the first acting group N, an element of the second subset and elements of the second acting group H plus the generating element to the power of the order of the generating element minus 1. The elements of the second acting group are powers of the generating element h of a power at most the order of the generating element minus 2. That is the elements of the first subset Δ are chosen to be β₀mᵢ_{₀}h⁰+ . . . βₖ₋₂mᵢ_{_{k−2}}h^{k-2}+mᵢ_{_{k−2}}h^{k-1}, with the βᵢ taken from the first acting group and the m from the second subset. It can be seen that this will produce a working first subset as follows: as any element can be written as m=γ₀mᵢ_{₀}h⁰+γ₁mᵢ_{₁}h¹+ . . . +γₖ₋₁mᵢ_{_{k−1}}h^{k-1}, the latter may be written as γₖ₋₁(γₖ₋₁⁻¹γ₀mᵢ_{₀}h⁰+ . . . +γₖ₋₁⁻¹γₖ₋₁mᵢ_{_{k−1}}h^{k-1}), which is a product from an element in the first action group (γₖ₋₁) and an element of the first subset as defined above. Note that typically there are many other possible choices for the first subset, some of which may be smaller than this example. However, this shows that given a second subset, a suitable first subset may be constructed at least in this manner.

The above construction of a first subset is also suited for the situation in which the second subset M₀ consists of a single element. In this case we get the elements β₀m₀h⁰+ . . . βₖ₋₂m₀h^{k-2}+m₀h^{k-1}, giving a considerable reduction in the size of the first subset. In general, having a small first subset reduces the number of normalized representations which in turn reduce the size of the addition tables. The addition tables represent an important part of the code size, especially of obfuscated, e.g., encoded, implementations.

Below a number of examples are given of main groups, acting groups and subsets.

In a first example: the main group is the group M= [symbol] ₃× [symbol] ₃. Elements of M can be represented as a column vector of two elements. The first acting group N is generated by the matrix

$$[ \begin{matrix}2 & 1 \\ 1 & 1\end{matrix} ] ,$$

and has size 4. The second acting group is generated by the element −1, H=<1>, and has size 2. The elements of the group H may be represented as +I and −I, in which I represents the identity matrix. The second subset is chosen as the set with the single element

$${m}_{0} = [ \begin{matrix}1 \\ 1\end{matrix} ] .$$

All elements of M may be written in generalized representation as γ₀m₀−γ₁m₀, with γ₀ and γ₁ in N. The first subset if chosen using the construction above as the set {xm₀−m₀}, with x ranging through all elements in N. Although the elements of the main group and the first and second acting group, and the first and second subset can be represented as matrices or vectors, as will be possible in general, they may also be represented in some encoded form, e.g., as indices in a random ordering of the corresponding groups or sets.

In a second example: the main group is M= [symbol] ₃⁴. The first acting group is generated by the matrix

$$[ \begin{matrix}0 & 2 & 2 & 0 \\ 2 & 1 & 1 & 2 \\ 2 & 2 & 2 & 0 \\ 2 & 0 & 1 & 2\end{matrix} ] ,$$

and has order 5. The second acting group is generated by the element −1, and has size 2. The first subset has three elements

$${M}_{0} = \{ [ \begin{matrix}0 \\ 2 \\ 0 \\ 0\end{matrix} ] , [ \begin{matrix}2 \\ 1 \\ 1 \\ 0\end{matrix} ] , [ \begin{matrix}0 \\ 0 \\ 1 \\ 2\end{matrix} ] \} .$$

The first subset is selecting by taking an arbitrary element in the orbits of N in group M. The first subset has 17 elements.

In a third example, the main group is M= [symbol] ₂⁶, a group of characteristic two. The first acting group N has 14 elements and is generated by

$$g = [ \begin{matrix}0 & 1 & 0 & 1 & 0 & 1 \\ 1 & 0 & 0 & 0 & 1 & 1 \\ 1 & 1 & 1 & 1 & 0 & 0 \\ 1 & 1 & 0 & 0 & 1 & 1 \\ 1 & 0 & 1 & 1 & 1 & 1 \\ 0 & 1 & 0 & 0 & 0 & 1\end{matrix} ] and s = [ \begin{matrix}1 & 1 & 0 & 0 & 1 & 0 \\ 0 & 1 & 0 & 1 & 0 & 0 \\ 0 & 1 & 1 & 0 & 1 & 1 \\ 0 & 0 & 0 & 1 & 0 & 0 \\ 0 & 0 & 0 & 1 & 1 & 0 \\ 0 & 0 & 0 & 0 & 0 & 1\end{matrix} ] .$$

The element g has order 7, the element s has order 2, and commute with each other. The first acting group N generated by g and s has order 14. All elements of N can be written as gⁱs^{j}, the pair of integers (i, j) can be used to represent an element of the first acting group. The second subset consists of a single element

$${m}_{0} = [ \begin{matrix}0 \\ 1 \\ 1 \\ 0 \\ 0 \\ 1\end{matrix} ]$$

The second acting group is the group of size 1 with only the identity element. The order k of the generating element is 1. In this case the upper bound on the exponents in generalized representation is increased from k−1 to 2k−1, thus having two summands. The first subset is chosen from orbits of N on M and has, in a minimal choice, 9 elements.

In a fourth example, the main group is M= [symbol] ₂⁴. Both the first and second acting groups are isomorphic to [symbol] ₃. The first acting group is generated by

$$[ \begin{matrix}0 & 1 & 1 & 0 \\ 0 & 1 & 1 & 1 \\ 1 & 0 & 0 & 1 \\ 1 & 1 & 0 & 1\end{matrix} ] ,$$

the second acting group is generated by

$$[ \begin{matrix}1 & 1 & 1 & 0 \\ 1 & 0 & 1 & 0 \\ 0 & 0 & 1 & 0 \\ 0 & 1 & 1 & 1\end{matrix} ] ;$$

both generators have order 3. The second subset has a single element

$${m}_{0} = [ \begin{matrix}1 \\ 0 \\ 0 \\ 0\end{matrix} ]$$

The first subset can be chosen with 6 elements from the orbits of N induced on M.

In a fifth example, the main group is M= [symbol] ₄². The first acting group has 6 elements and is generated by

$$[ \begin{matrix}3 & 3 \\ 1 & 2\end{matrix} ] ,$$

the second acting group has 2 elements and is generated by

$$[ \begin{matrix}1 & 2 \\ 2 & 3\end{matrix} ] .$$

The second subset has a single element

$$[ \begin{matrix}2 \\ 3\end{matrix} ] .$$

The first subset can be chosen from the orbits and may contain 5 elements.

Throughout the examples, the size of the second acting group may be increased to create more generalized representations Likewise the sizes of the first and second subset may be increased. The addition tables can be computed from the defining equation.

In general given an Abelian group M, the other elements may be chosen as follows. The group M may be written as a product of [symbol] _{d}_{₁}× [symbol] _{d}_{₂}× . . . × [symbol] _{d}_{ₜ}, with d₁|d₂ . . . |dₜ. This means that it suffices to find the elements for M⁺=( [symbol] _{d}_{ₜ})^{t}, and then project to M. One may follow the following procedure:

1. Obtain generators for the automorphism group of M⁺, e.g., the invertible elements of the matrix group Mat_{t×t}( [symbol] _{d}_{ₜ}).

2. Select an element h in the automorphism group, e.g., as a random product of generators. H is obtained as the group generated by h.

3. Choose the group N as a subgroup of the automorphism group. For example, choose one, two or more generators in the automorphism groups. The generators are selected to commute with the group H. Note that finding such generators for N may be done by solving a linear system of equations on the elements of the generator, when viewed as a matrix.

4. Finally select the first and second sets m₀ and Δ. The latter can be obtained from the computing the orbits of the N. The former may be selected, e.g., by incrementally enlarging the empty set.

Finally, it is decided if the thus obtained arithmetic satisfies constraints, e.g., on the size of H, on the number of generalized representations etc, and if not, e.g., the process may be repeated from step 2. Note that different algorithms are possible, for example, one may swap steps 2 and 3. These constructions allow e.g. for efficient memory use.

FIG. 1 shows two options for receiving input at calculating device 100. Calculating device 100 may comprise an encoding unit 170 arranged to receive unencoded input, e.g., an element of main group M in any conventional format. Encoding unit 170 transforms the input to either the normal or generalized representation. In an embodiment encoding unit 170 comprises an encoding table for mapping elements of group M to a normal or generalized representation. In an embodiment, encoding unit 170 produces generalized elements. Encoding unit 170 need not be part of calculating device 100; for example, calculating device may receive input directly in encoded format, in particular in generalized representation. For example, the latter may be achieved by having an encoding unit 170 at an external computer from which direct input 171 is received.

In an embodiment, multiple encoding units 170 are produced for the same calculating device 100. The multiple encoding units 170 are arranged to receive unencoded input and to transform the input to generalized representation. The multiple encoding units 170 use a different generalized representation. For example, for any two encoding units of the multiple encoding units, there is an element x of the main group M, such that x is encoded differently by the two encoding units. For example, in an embodiment, there is an element x of the main group M that is encoded differently by the each on the multiple encoding units.

Also output of calculating device 100 may be decoded by a decoding unit 160. Alternatively, the output of calculating device 100 may be returned in encoded format, e.g., normalized or generalized representation. Locally, at an external computer the encoding may be removed, say by a decoding unit 160. Accordingly, units 160 and 170 may both be omitted from device 100.

FIG. 1d shows in schematic form a refinement of calculating device 100′ which includes a multiplication unit 140. Calculating device 100′ may be the same as calculating device 100 except as indicated below.

In this case the main group (M, +) is also a ring (R, +, ·); in addition to an addition also a multiplication is defined. The multiplication is associative, is distributive over the Abelian group operation, and has an identity element. The identity for the multiplication is often written as 1.

For convenience of notation, in this section right notation is used for the acting of the first acting group. This means that a normalized element is written as Xα, with X in the first subset and α in the first acting group. The first and second acting groups are taken from the automorphism group of M as a ring, e.g., the set of ring-isomomorphisms of the main ring M to itself.

Multiplication unit 140 is arranged to receive a first multiplication input 141 and a second multiplication input 142. FIG. 1c gives a possible embodiment of multiplication unit 140 in schematic form. First multiplication input 141 and second multiplication input 142 are elements of the main group (R), which in this case is in fact a ring. First multiplication input 141 is received in normalized representation Xα, and the second multiplication input 142 in generalized representation. Multiplication unit 140 is arranged to compute a product in the ring (R) of first multiplication input 141 and second multiplication input 142.

Multiplication unit 140 is arranged to

compute a first addition input 145 from the first multiplication input 141 and a first summand of the second multiplication input 142, the first addition input being in normalized form, and

compute one or more second addition inputs 146 from the first multiplication input and multiple summand of the second multiplication input 142 other than the first summand that was used to compute the first addition input 145. The one or more second addition inputs 146 are in generalized form.

Multiplication unit 140 may comprise an intermediate multiplication unit 144 arranged to compute first addition input 145 and the one or more second addition inputs 146 from first multiplication input 141 and second multiplication input 142, as shown in FIG. 1c. Determining the addition inputs may involve operations in the first and second acting group, but does not require the addition tables. After the conversion from multiplication inputs to addition inputs, first addition input 145 and the one or more second addition inputs 146 are added, e.g., through addition unit 130.

Because the same table is used for addition and multiplication it would be hard to see during reverse engineering if an addition or a multiplication is performed. Even if an attacker were able to find the table that is used, and even if he were able to figure out somehow its function as an addition table, he still would not know whether addition or multiplication operations are performed. Furthermore, as no additional tables are needed for multiplication, code size is reduced.

In an embodiment, the first N and second H acting groups are subgroups of the group of units of the ring U(R), acting on the main group through multiplication, the second subset M₀ comprising only the identity element of the main group, e.g., the element m₀=1. In this case, the first subset may be constructed as indicated above as the elements β₀h⁰+ . . . βₖ₋₂h^{k-2}+h^{k-1}. In this case first multiplication input 141 has the form ((β₀h⁰+ . . . βₖ₋₂h^{k-2}+h^{k-1})α=Xα), and second multiplication input 142 has the form (γ₀h⁰+γ₁h¹+γ₂h²+ . . . ).

Below an example is given of a conversion algorithm, converting multiplication inputs to addition inputs. Let the first multiplication input 141 be r=Xα=(β₀h⁰+ . . . βₖ₋₂h^{k-2}+h^{k-1})α, and the second multiplication input 142 r′=γ₀h⁰+γ₁h¹+γ₂h²+ . . . +γₖ₋₁h^{k-1}. The multiplication r·r′ is done with each summand of ′. The first one is rγ₀h⁰=X(αγ₀), this normalized element is the first multiplication input 145. The following ones are Xαγᵢhⁱ, with i>0. Using straightforward computation, using distributivity and the fact that h^{k}=1, we obtain a general representation of Xαγᵢhⁱ. This process generates k−1 addition inputs 146 in general representation that will be added with the addition formulas for the first addition input 145, which is a normalized element. The number of additions increases with k. Using k=2, implies the multiplication and the addition have the same complexity, making it harder for the attacker to distinguish addition and multiplication operations in the code.

In an embodiment, the first N and second H acting groups are subgroups of the group of units of the ring U(R), acting on the main group through multiplication, the second subset M₀ comprising only the identity element of the main group.

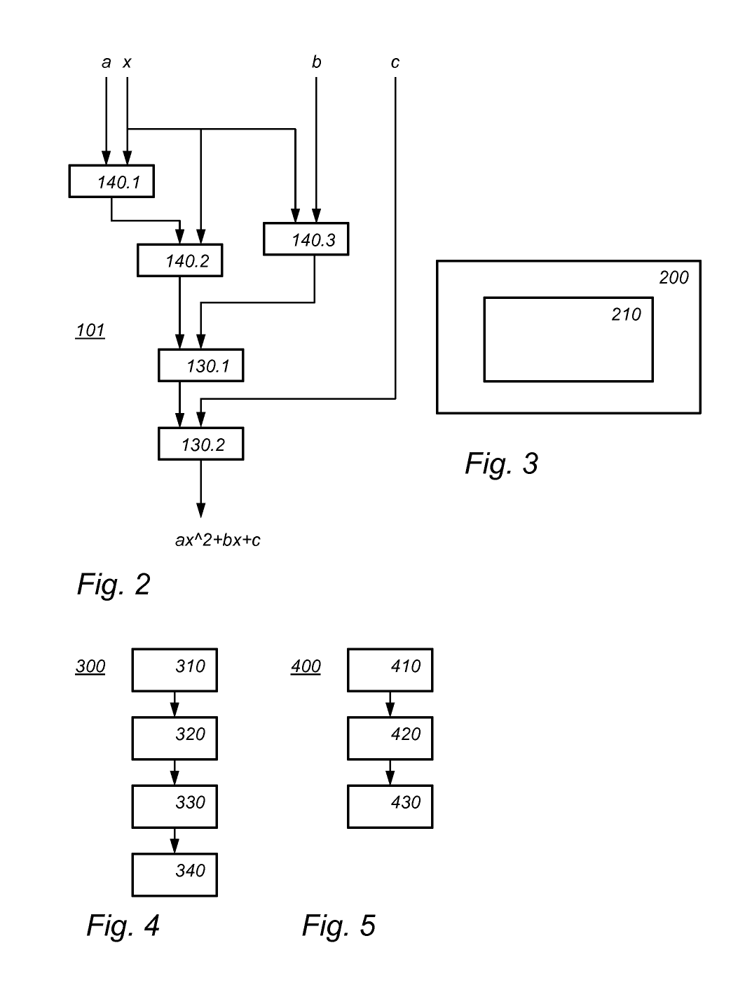

FIG. 2 schematically shows an example of an embodiment of a calculating device 101. Calculation device 101 is a refinement of calculation device 100′. In an embodiment, calculation device 101 comprises multiple addition units, and multiple multiplication units. For example, FIG. 2 shows three multiplication units, 1401.1, 140.2, and 140.3 and two addition units 130.1 and 130.2. These units may be of the same design as units 140 and 130 respectively. The multiplication and addition units take relatively little space, e.g., when implemented in software these units need not be more than a few hundred low-level computer instructions. In particular, a copy of the addition and/or multiplication unit may be used for each multiplication or addition that is required in a computer program. This allows traditional obfuscation techniques to makes these copies different such that an attacker cannot see that the same operator is used. Depending, e.g., on the obfuscation used a multiplication and/or addition unit may be reused for multiple calculations. As an example, FIG. 2 shows how the polynomial ax²+bx+c may be computed using obfuscated arithmetic.

The operations of multiple arithmetic units, e.g., addition, multiplication, may be in any order allowed by their data dependencies. For example, operation 140.3 may be inserted in the ordering 140.1, 140.2, 130.1, and 130.2 at any point before 130.1. Moreover the ordering of subsequent multiplications or additions may be reversed. Thus a diagram like diagram 2 may be translated in a linear ordering for a software program in many ways. It is not needed that the units are strictly separated; instructions for a first unit may be interspersed with instructions for another unit.

FIG. 3 schematically shows an example of an embodiment of a table computation device 200 for computing an addition table for use in a calculating device. The addition table may be used in a device like calculation device 100, etc. The addition table may be stored on a non-transient storage device, e.g., a hard disk, a non-volatile memory chip etc.

Table computation device 200 is arranged for computing a look-up table for use in an electronic calculating device arranged to add two elements of a main group ((M, +)), the main group being a finite Abelian group ( [symbol] ₚ_{₁}k₁ ⊕ . . . ⊕ [symbol] ₚ_{ₜ}kₜ).

The table computation device comprises a table creation unit 210 arranged to construct the look-up table for an element mᵢ of the second subset M₀. The table creation unit is arranged to
repeatedly select an input normalized element (γ, X) of the main group M. For example, the device 200 may select an element of the first acting group and of the first subset to select the normalized element.
determine the sum s=γX+mᵢ of the input normalized element γX and said element mᵢ of the second subset M₀. This addition may be done in the main group M. For example, both the input normalized element and mᵢ may be converted to a canonical representation of M. It is not objection that device 200 calculates in main group M, without obfuscation, as device 200 will typically not be part of the calculation device 100 itself.
determine an element λ of the first acting group N and an element Y of the first subset Δ, so that a product of the element λ of the first acting group N and the element Y of the first subset Δ is said sum: λYh=s=γX+mᵢ. For example, one may compute sh⁻¹ and convert this to normalized form, e.g., using a conversion table. Alternatively, one may compute the sums for all normalized elements, creating a table of sums, and next loop through all normalized elements λY, and determining which sum equals λYh.
add an entry to the look-up table mapping the input ring element to the element λ of the first acting group N and the element Y of the first subset Δ.

The result is a table for element mᵢ of the second subset M₀. The table creation may be repeated for all other elements of the second subset.

Operand storage 150, Addition table storage 110, etc, may be implemented as an electronic memory. Parts of the memory may be volatile or non-volatile. For example, they may comprise SRAM, FLASH or ROM memory. Other storage technology, e.g., magnetic storage, cloud storage, etc, may also be used. Advantageously the storage used allows for fast random-access, e.g. closely/tightly coupled memory.

Typically, the devices 100, 100′ and the 200 each comprise a microprocessor (not separately shown) which executes appropriate software stored at the device; for example, that software may have been downloaded and/or stored in a corresponding memory, e.g., a volatile memory such as RAM or a non-volatile memory such as Flash (not separately shown). The devices 100, 100′, and 200 may also be equipped with microprocessors and memories (not separately shown). Alternatively, the devices may, in whole or in part, be implemented in programmable logic, e.g., as field-programmable gate array (FPGA). Devices 100, 100′ and 200 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

An embodiment of a calculating may comprises an addition circuit, conversion circuit, function circuit, and/or multiplication circuit, etc. The circuits implement the corresponding units described herein. The circuits may be a processor circuit and storage circuit, the processor circuit executing instructions represented electronically in the storage circuits. The circuits may also be, FPGA, ASIC or the like.

FIG. 3 is a flowchart illustrating in a schematic way an electronic calculating method 300 for adding two elements of a main group ((M, +)), the main group being a finite Abelian group ( [symbol] ₚ_{₁}k₁ ⊕ . . . ⊕ [symbol] ₚ_{ₜ}kₜ).

Method 300 comprises

storing 310 for each element (mᵢ) of the second subset (M₀) a look-up table (Pᵢ), said look-up table taking as input a normalized element ((γ, X)) of the main group (M) and mapping the input to an element (λ) of the first acting group (N) and an element (Y) of the first subset (Δ), a product of the element (λ) of the first acting group (N) and the element (Y) of the first subset (Δ) being the sum (ΔYh=γX+mᵢ) of the normalized element (γX) and said element (mᵢ) of the second subset (M₀). For example, the storing may be executed by having a memory on which the addition tables are stored.

receiving 320 a first addition input (α₀X₀) and a second addition input (γ₀mᵢ_{₀}h⁰+γ₁mᵢ_{₁}h¹+γ₂mᵢ_{₂}h²+ . . . ), the first and second addition inputs being elements of the main group (M), wherein the first addition input is received in normalized representation and the second addition input in generalized representation, and computing a sum in the main group (M) of the first addition input and the second addition input, wherein the computing comprises

computing 330 partial sums by sequentially adding the summands of the second addition input to the first addition input, wherein

adding 340 a summand (γₜmᵢ_{ₜ}h^{t}) of the second addition input to the partial sum comprises applying the look-up table (Pᵢ_{ₜ}) for the element (mᵢ_{ₜ}) of the second subset (M₀) in said summand.

FIG. 5 shows a flow-chart illustrating in schematic form a table computation method 400 for computing a look-up table for use in an electronic calculating device arranged to add two elements of a main group ((M, +)), the main group being a finite Abelian group ( [symbol] ₚ_{₁}k₁ ⊕ . . . ⊕ [symbol] ₚ_{ₜ}kₜ), the table computation method comprising,

repeatedly (410) selecting an input normalized element ((γ, X)) of the main group (M)

determining the sum (λYh=γX+mᵢ) of the input normalized element (γX) and said element (mᵢ) of the second subset (M₀),

determining (420) an element (λ) of the first acting group (N) and an element (Y) of the first subset (Δ), so that a product of the element (λ) of the first acting group (N) and the element (Y) of the first subset (Δ) is said sum

adding (430) an entry to the look-up table mapping the input ring element to the element (λ) of the first acting group (N) and the element (Y) of the first subset (Δ).

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to the invention may be executed using software, which comprises instructions for causing a processor system to perform method 300 and 400. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

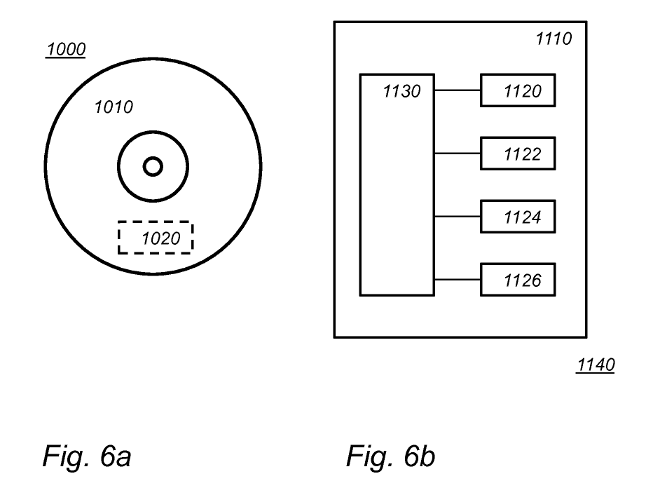

FIG. 6a shows a computer readable medium 1000 having a writable part 1010 comprising a computer program 1020, the computer program 1020 comprising instructions for causing a processor system to perform a calculating method for adding two elements of a main group or a method for computing a look-up table for use in an electronic calculating device, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method of a calculating method for adding two elements of a main group or a method for computing a look-up table for use in an electronic calculating device.

FIG. 6b shows in a schematic representation of a processor system 1140 according to an embodiment. The processor system comprises one or more integrated circuits 1110. The architecture of the one or more integrated circuits 1110 is schematically shown in FIG. 6b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of embodiments or to formulas of embodiments, thus increasing the intelligibility of the claim. These references shall not be construed as limiting the claim.

### LIST OF REFERENCE NUMERALS IN FIGS. 1a-1d

100 a calculating device
110 an addition table storage
122 a conversion unit
124 a function unit
130 a addition unit
131 first addition input
132 second addition input
133 a partial sum
134 an partial addition unit
140 a multiplication unit
141 a first multiplication input
142 a second multiplication input
144 an intermediate multiplication unit
145 a first addition input
146 one or more second addition inputs
150 an operand storage
152 a constant storage
160 a decoding unit
170 an encoding unit
171 a direct input
172 a storage arranged to store an encoding table

1. An electronic calculating device arranged to add two elements of a main group ((M, +)), the main group being a finite Abelian group ( [symbol] ₚ_{₁}k₁ ⊕ . . . ⊕ [symbol] ₚ_{ₜ}kₜ),
defined for the main group are
a first (N) and second (H) acting group, the first (N) and second (H) acting groups acting on the main group (M), the second acting group (H) being a cyclic group generated (H= [symbol] h [symbol] ) by a generating element (h),
a first subset (Δ) of the main group (M) such that any element (m) of the main group (M) can be expressed (m=nX) as a product of an element (n) of the first acting group (N) and an element (X) of the first subset (Δ), the element (n) of the first acting group (N) and the element (X) of the first subset (Δ) being referred to as a normalized representation of the element (m) of the main group (M),
a second subset (M₀={m₀, . . . , mᵣ₋₁}) of the main group (M) such that any element (m) of the main group (M) can be expressed as a sum of multiple summands, each summand being a product of an element (γₜ) of the first acting group (N), an element (mᵢ_{ₜ}) of the second subset (M₀) and a power (h^{t}) of the generating element (m=Σₜγₜmᵢ_{ₜ}h^{t}), the multiple elements of the first acting group in the multiple summands being referred to as a generalized representation of the element (m) of the main group (M),
the calculating device comprising
an addition table storage storing for each element (mᵢ) of the second subset (M₀) a look-up table (Pᵢ), said look-up table taking as input a normalized element ((γ, X)) of the main group (M) and mapping the input to an element (λ) of the first acting group (N) and an element (Y) of the first subset (Δ), a product of the element (λ) of the first acting group (N) and the element (Y) of the first subset (Δ) being the sum (λYh=γX+mᵢ) of the normalized element (γX) and said element (mᵢ) of the second subset (M₀),
an addition unit arranged to receive a first addition input (α₀X₀) and a second addition input (γ₀mᵢ_{₀}h⁰+γ₁mᵢ_{₁}h¹+γ₂mᵢ_{₂}h²+ . . . ), the first and second addition inputs being elements of the main group (M), wherein the first addition input is received in normalized representation and the second addition input in generalized representation, and to compute a sum in the main group (M) of the first addition input and the second addition input, wherein the addition unit is arranged to
compute partial sums by sequentially adding the summands of the second addition input to the first addition input, wherein
adding a summand (γₜmᵢ_{ₜ}h^{t}) of the second addition input to the partial sum comprises applying the look-up table (Pᵢ_{ₜ}) stored in the addition table storage for the element (mᵢ_{ₜ}) of the second subset (M₀) in said summand.

2. An electronic calculating device as in claim 1, wherein
an element (m) of the main group (M) in normalized representation is represented in the calculating device as a pair of two numbers, a first number of the two numbers indicating the element (n) of the first acting group (N), a second number of the two numbers indicating the element (X) of the first subset (Δ), and
an element (m) of the main group (M) in generalized representation is represented in the calculating device as at least a first sequence of numbers, the first sequence indicating the elements (γₜ) of the first acting group (N) in the summands.

3. An electronic calculating device as in claim 1, wherein
the sum computed by the addition unit is represented in normalized form.

4. An electronic calculating device as in claim 1, comprising
a network interface arranged to receive one or more addition inputs from a computer external to the electronic calculating device, the one or more addition inputs being in generalized representation, and
a constant storage arranged to store one or more constant addition inputs in normalized representation,
the calculating device being arranged to add a selected addition input received through the network interface and a selected constant addition input from the constant storage, using the addition unit.

5. An electronic calculating device as in claim 1, comprising
a conversion unit arranged to receive a conversion input, wherein
the conversion input is in generalized form, the conversion unit being arranged to convert the conversion input to normalized form by adding an element of the main group in normalized form, and/or
the conversion input is in normalized input, the conversion unit storing a conversion table mapping elements of the first subset to a generalized form.

6. An electronic calculating device as in claim 1, comprising
a function unit arranged to apply a linear function (ƒ) to a function input in generalized form, and
a linear function table storage, storing a table taking as input a product of an element (γₜ) of the first acting group (N), an element (mᵢ_{ₜ}) of the second subset (M₀) and a power (h^{t}) of the generating element (m=Σₜγₜmᵢ_{ₜ}h^{t}) and mapping the product to the result of applying the linear function to the product, wherein
the function unit is arranged to apply the table of the linear function table storage to the summands of the function input.

7. An electronic calculating device as in claim 1, wherein
the second acting group (H) has 3 or more elements, or
the second acting group (H) has 2 elements, or
the second subset (M₀) has 2 or more elements, or
the second subset (M₀) has 1 element which is not the identity, or
the main group (M) is the Abelian group [symbol] ₂^{l}, for example, with l≥4, or
the first acting group (N) is a cyclic group with 3 or more elements.

8. An electronic calculating device as in claim 1, wherein the generating element (h) has order k, an exponent (t) of the generating element (h) in a generalized representation is at most a particular multiple of the order (k) minus 1 (t≤λk−1), the particular multiple being the same for all elements of the main group.

9. An electronic calculating device as in claim 8, wherein
the main group has characteristic 2, and the second acting group has order 2, and the power (h^{t}) of the generating element (h) in a generalized representation is at most the twice the order minus 1 (t≤2k−1), or
the main group has characteristic larger than 2 or the order of the second acting group is larger than 2, and the power (h^{t}) of the generating element (h) in a generalized representation is at most the order minus 1 (t≤k−1).

10. An electronic calculating device as in claim 1, wherein
the addition unit is arranged to
set the partial sum initially to the first addition input (α₀X₀), and
loop over the summand of the first addition input, in each loop updating the partial sum by adding the summand of the first addition input (γₜmᵢ_{ₜ}h^{t}).

11. An electronic calculating device as in claim 10, wherein
the first addition input is the element α₀X₀ of the main group with α₀ ∈ N, and X₀ ∈ Δ, and the second addition input is the element γ₀mᵢ_{₀}h⁰+γ₁mᵢ_{₁}h¹+γ₂mᵢ_{₂}h²+ . . . γ_{λk-1}mᵢ_{_{λk−1}}h^{λk-1} of the main group, wherein k is the order of the generating element, γᵢ ∈ N, and mᵢ ∈ M₀, and h is the generating element
the addition unit being arranged to
set the partial sum initially to the first addition input α₀X₀,
for each exponent (t) of the generating element (h^{t}) from 0 to λk−1,
obtaining the next partial sum (αₜ₊₁Xₜ₊₁) from the current partial sum (αₜXₜ) by adding the summand corresponding to the exponent (γₜmᵢ_{ₜ}h^{t}), by applying the look-up table (Pᵢ_{ₜ}) for mᵢ_{ₜ} to γₜ⁻¹γₜ₋₁αₜXₜ, wherein γ₋₁ is the identity in the main group (M) and wherein αₜXₜ is the current partial sum,
the partial sum being equal to γₜ₋₁αₜXₜh^{t}.

12. An electronic calculating device as in claim 1, wherein the first subset (Δ) comprises only elements formed by summing products of elements of the first acting group (N), elements of the second subset, and elements of the second acting group (H) plus the generating element to the power of the order of the generating element minus 1 (β₀mᵢ_{₀}h⁰+ . . . βₖ₋₂mᵢ_{_{k−2}}h^{k-2}+mᵢ_{_{k−2}}h^{k-1}), wherein said elements of the second acting group are powers of the generating element (h) of a power at most the order of the generating element minus 2.

13. An electronic calculating device as in claim 12, wherein the main group ((M, +)) has an additional operation (⁻) making the main group into ring ((R, +, ·)), the electronic calculating device comprising
a multiplication unit arranged to receive a first multiplication input and a second multiplication input, the first and second multiplication inputs being elements of the main ring (R), wherein the first multiplication input is received in normalized representation ((β₀h⁰+ . . . βₖ₋₂h^{k-2}+h^{k-1})α=Xα) and the second multiplication input in generalized representation (γ₀h⁰+γ₁h¹+γ₂h²+ . . . ), and to compute a product in the ring (R) of the first multiplication input and the second multiplication input, wherein the multiplication unit is arranged to
compute a first addition input from the first multiplication input and a first summand of the second multiplication input, the first addition input being in normalized form (X(αγ₀)),
compute one or more second addition inputs from the first multiplication input and multiple summand of the second multiplication input other than the first summand, the one or more second addition inputs being in generalized form (X(αγᵢ)hⁱ=(Xhⁱ)n′),
add the first addition input and the one or more second addition inputs through the addition unit.

14. An electronic calculating device as in claim 1, wherein
(#N·#M₀)^{#H}≥3/2(#N·#Δ)
more in particular wherein
(#N·#M₀)^{#H}≤5/2(#N·#Δ)
wherein
#N is the size of the first acting group (N),
#H is the size of the second acting group (H),
#Δ is the size of the first subset (Δ),
#M₀ is the size of the second subset (M₀),
#M is the size of the main group (M).

15. A table computation device for computing a look-up table for use in an electronic calculating device arranged to add two elements of a main group ((M, +)), the main group being a finite Abelian group ( [symbol] ₚ_{₁}k₁ ⊕ . . . ⊕ [symbol] ₚ_{ₜ}kₜ), the table computation device comprising,
a table creation unit arranged to construct the look-up table for an element (mᵢ) of the second subset (M₀), the table creation unit being arranged to
repeatedly select an input normalized element ((γ, X)) of the main group (M)
determine the sum (λYh=γX+mᵢ) of the input normalized element (γX) and said element (mᵢ) of the second subset (M₀),
determine an element (λ) of the first acting group (N) and an element (Y) of the first subset (Δ), so that a product of the element (λ) of the first acting group (N) and the element (Y) of the first subset (Δ) is said sum
add an entry to the look-up table mapping the input ring element to the element (λ) of the first acting group (N) and the element (Y) of the first subset (Δ).

16. An electronic calculating method for adding two elements of a main group ((M, +)), the main group being a finite Abelian group ( [symbol] ₚ_{₁}k₁ ⊕ . . . ⊕ [symbol] ₚ_{ₜ}kₜ),
defined for the main group are
a first (N) and second (H) acting group, the first (N) and second (H) acting groups acting on the main group (M), the second acting group (H) being a cyclic group generated (H= [symbol] h [symbol] ) by a generating element (h),
a first subset (Δ) of the main group (M) such that any element (m) of the main group (M) can be expressed (m=nX) as a product of an element (n) of the first acting group (N) and an element (X) of the first subset (Δ), the element (n) of the first acting group (N) and the element (X) of the first subset (Δ) being referred to as a normalized representation of the element (m) of the main group (M),
a second subset (M₀={m₀, . . . , mᵣ₋₁}) of the main group (M) such that any element (m) of the main group (M) can be expressed as a sum of multiple summands, each summand being a product of an element (γₜ) of the first acting group (N), an element (mᵢ_{ₜ}) of the second subset (M₀) and a power (h^{t}) of the generating element (m=Σₜγₜmᵢ_{ₜ}h^{t}), the multiple elements of the first acting group in the multiple summands being referred to as a generalized representation of the element (m) of the main group (M),
the calculating method comprising
storing for each element (mᵢ) of the second subset (M₀) a look-up table (Pᵢ), said look-up table taking as input a normalized element ((γ, X)) of the main group (M) and mapping the input to an element (λ) of the first acting group (N) and an element (Y) of the first subset (Δ), a product of the element (λ) of the first acting group (N) and the element (Y) of the first subset (Δ) being the sum (λYh=γX+mᵢ) of the normalized element (γX) and said element (mᵢ) of the second subset (M₀),
receiving a first addition input (α₀X₀) and a second addition input (γ₀mᵢ_{₀}h⁰+γ₁mᵢ_{₁}h¹+γ₂mᵢ_{₂}h²+ . . . ), the first and second addition inputs being elements of the main group (M), wherein the first addition input is received in normalized representation and the second addition input in generalized representation, and computing a sum in the main group (M) of the first addition input and the second addition input, wherein the computing comprises
computing partial sums by sequentially adding the summands of the second addition input to the first addition input, wherein
adding a summand (γₜmᵢ_{ₜ}h^{t}) of the second addition input to the partial sum comprises applying the stored look-up table (Pᵢ_{ₜ}) for the element (mᵢ_{ₜ}) of the second subset (M₀) in said summand.

17. A table computation method for computing a look-up table for use in an electronic calculating device arranged to add two elements of a main group ((M, +)), the main group being a finite Abelian group ( [symbol] ₚ_{₁}k₁ ⊕ . . . ⊕ [symbol] ₚ_{ₜ}kₜ), the table computation method comprising,
repeatedly selecting an input normalized element ((γ, X)) of the main group (M)
determining the sum (λYh=γX+mᵢ) of the input normalized element (γX) and said element (mᵢ) of the second subset (M₀),
determining an element (λ) of the first acting group (N) and an element (Y) of the first subset (Δ), so that a product of the element (λ) of the first acting group (N) and the element (Y) of the first subset (Δ) is said sum
adding an entry to the look-up table mapping the input ring element to the element (λ) of the first acting group (N) and the element (Y) of the first subset (Δ).

18. A computer program comprising computer program instructions arranged to perform the method of claim 16 when the computer program is run on a computer.

19. A computer readable medium comprising the computer program as in claim 18.
